(19) United States
(12) Patent Application Publication
(10) Pub. No.: US 2025/0085703 A1
(43) Pub. Date: Mar. 13, 2025

(54) FAULT DIAGNOSIS IN MULTI-COMPONENT SYSTEMS

(71) Applicant: EATON INTELLIGENT POWER LIMITED, Dublin (IE)

(72) Inventors: VijayaKumar Pasupureddy, Mandavakurity (IN); Karthikeyan Sundararajan Chokappa, Pune (IN)

(21) Appl. No.: 18/729,368

(22) PCT Filed: Mar. 15, 2022
(86) PCT No.: PCT/EP2022/056618

§ 371 Date: Jul. 16, 2024

(30) Foreign Application Priority Data
Jan. 13, 2022 (IN) 202211002140

(51) Int. Cl. G05B 23/02

(52) U.S. Cl. CPC G05B 23/0235; G05B 23/0275

(57) ABSTRACT

Some embodiments relate to a computer-implemented method of addressing faults in a system comprising at least one controller is described. The method comprises receiving fault information from one controller for one or more faults. The fault information comprises at least an identification of the device showing the fault and a time period during which the fault occurs. From this fault information, a plurality of fault baskets is established, wherein each fault basket for a fault comprises that fault and at least other faults in the system active at the time the fault occurs. The plurality of fault baskets is mined to identify one or more fault rules and associated fault baskets. It is then determined whether each fault rule meets a significance threshold, and if so, a corrective or preventative action for such fault rules is determined.

### CROSS-REFERENCE TO RELATED APPLICATIONS

This application is a national phase filing under 35 C.F.R. § 371 of and claims priority to PCT Patent Application No. PCT/EP2022/056618, filed on Mar. 15, 2022, which claims the priority benefit under 35 U.S.C. § 119 of Indian Patent Application number 202211002140, filed on Jan. 13, 2022, the contents of which are hereby incorporated in their entireties by reference.

### TECHNICAL FIELD

The disclosure relates to fault diagnosis in multi-component systems. It has particular relevance to systems in which multiple components are monitored by, or are adapted to report to, a controller.

### BACKGROUND

Complex multi-component systems are frequently provided with controllers. In addition to control, such controllers will typically monitor components in the system—either actively by measurement or interrogation or passively by receiving reports—and will either perform diagnostics themselves, or they will report back to an external system for diagnosis of faults. This approach is frequently used in automotive systems—for example in engine or transmission management—but is also used in a wide variety of other systems.

In a vehicle, a typical approach may be for a diagnostics-enabled component or device to message a controller for its network with a fault code when there is a faulty condition. In an automotive environment, a fault code will be a combination of a Suspect Part Number (SPN) and a Fault Model Indicator (FMI). While the default approach would be to replace the part associated with the fault code, this may not be the correct solution. A fault indication in one component may in practice be a downstream consequence of a fault elsewhere in the system, or it may be an expression of a deeper systemic fault.

Diagnosis of such faults may be possible with an understanding of what other faults also arising could be associated with the first fault. This is challenging in environments where there are multiple controllers, and also where the diagnostic process is remote because communication issues may constrain or delay flow of data. However, a remote diagnostics process also has the advantage that it is typically possible to consider data from a number of relevant sources (for example, a fleet of trucks with the same transmission system) and so it may be possible to perform any analysis over a large data set.

It would be desirable to diagnose complex or systemic faults in multi-component systems more effectively. This could be of particular value in fields such as automotive diagnostics—for example, if faults can be used to predict future failure conditions to enable maintenance actions to be taken before failure.

### SUMMARY OF DISCLOSURE

In a first aspect, the disclosure provides a computer-implemented method of addressing faults in a system comprising at least one controller, wherein the method comprises: receiving fault information from the at least one controller for one or more faults, wherein the fault information comprises at least an identification of the device showing the fault and a time period during which the fault occurs; establishing a plurality of fault baskets, wherein each fault basket for a fault comprises that fault and at least other faults in the system active at the time the fault occurs; mining the plurality of fault baskets to identify one or more fault rules and associated fault baskets; determining whether each fault rule meets a significance threshold; and establishing a corrective or preventative action for fault rules that meet the significance threshold.

Using this approach, emerging and established fault rules can be identified effectively from a complex assemblage of data—fault information may be obtained from a large number of vehicles, which will themselves comprise an assemblage of diverse components with many parameters varying between vehicles. These fault rules can be used to establish corrective actions —and hence, for example, predictive maintenance schedules—based on actual performance data.

Fault baskets may be of different types. In embodiments, one type of fault basket may also contain inactive faults which were active before the start of the fault for which the fault basket is established but which also became inactive before the start of the fault for which the fault basket is established. Such inactive faults may be included in the fault basket if they meet a proximity threshold. In particular embodiments, each fault has associated with it a fault basket including only other active faults and a fault basket including both other active faults and inactive faults.

In embodiments, the step of mining the plurality of fault baskets may comprise a plurality of fault basket mining stages, wherein for each mining stage, fault rules are established, and one or more fault baskets are associated with each fault rule, and for subsequent mining stages, only fault baskets not already associated with a fault rule are considered. A first mining stage may then involve establishing fault rules common to a device or device family in which the fault occurs. One or more subsequent mining stages may involve establishing fault rules common to a product incorporating or associated with a device or device family in which the fault occurs or having a common system parameter in a system incorporating the device or device family in which the fault occurs. A subsequent mining stage may involve applying a fault rule established at an earlier mining stage to fault baskets not yet associated with any fault rule.

In embodiments, determining whether each fault rule meets a significance threshold comprises determining whether that fault rule is established or emerging. Fault rules which are declining, or not sufficiently strongly evidenced to be considered established, may not justify action being taken.

In embodiments, such method steps are carried out by a diagnostics system, and wherein the diagnostics system receives fault information from a plurality of controllers in a plurality of different systems having devices of the same type therein. This diagnostics system may be remote from the plurality of controllers and receives fault information from the plurality of controllers over one or more networks.

In a second aspect, the disclosure provides a method of determining maintenance actions for a device or for a product comprising a device, wherein, the method comprises a method of addressing faults in a system as set out in methods of the first aspect, and further comprises determining a maintenance schedule for the device or the product containing the device to carry out the corrective or preventative actions for fault rules that meet the significance threshold established thereby.

Such a product may be a vehicle, and the device may be a transmission or an engine.

In a third aspect, the disclosure provides a diagnostics system being a computer system having a processor and a memory, wherein the diagnostics system is programmed to perform methods of the first aspect or the second aspect. Such a diagnostics system may comprise a network connection and may be further adapted to receive fault information from a plurality of controllers from a plurality of systems using the network connection.

### BRIEF DESCRIPTION OF FIGURES

Embodiments of the disclosure will now be described, by way of example, with reference to the following figures, in which:

FIG. 1 shows an exemplary arrangement for remote diagnosis of faults in automotive systems to which embodiments of the disclosure are applicable;

FIG. 2 indicates fault categories in a vehicle control network in controller systems of the type shown in FIG. 1;

FIG. 3 illustrates the steps of a fault basket generation and analysis process according to an embodiment of the disclosure;

FIG. 4 shows a process of fault collection and organisation according to the process shown in FIG. 3;

FIG. 5 shows a process of fault basket generation according to the process shown in FIG. 3;

FIG. 6 shows a process of fault mining for product groups according to the process shown in FIG. 3;

FIG. 7 shows a process of fault mining for product families according to the process shown in FIG. 3;

FIG. 8 shows a process of determining whether fault patterns detected in one group are applicable to other groups according to the process shown in FIG. 3;

FIG. 9 shows a process of identifying special fault issues and associated rules according to the process shown in FIG. 3;

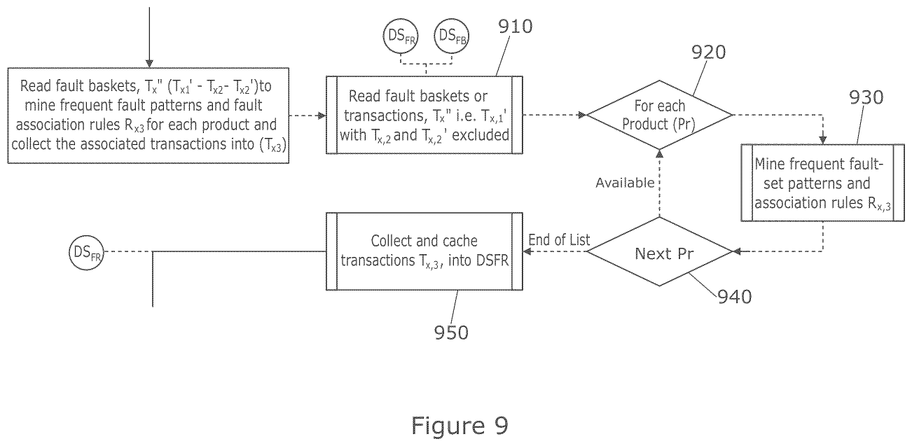

FIG. 10 shows a process of collecting and storing fault issues and fault rules for subsequent use according to the process shown in FIG. 3; and

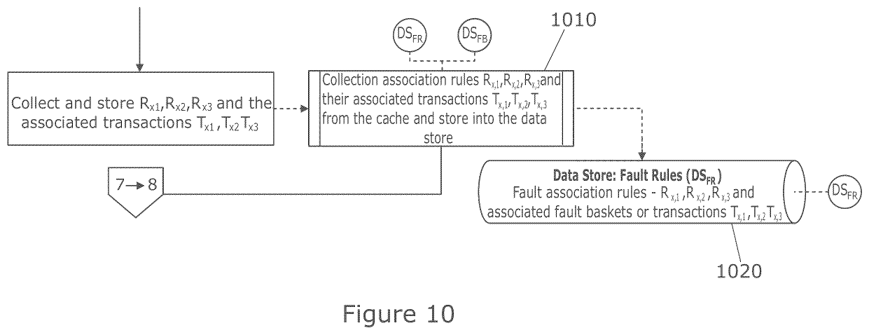

FIG. 11 shows a process for establishing emerging rules in accordance with the process shown in FIG. 3.

### DETAILED DESCRIPTION

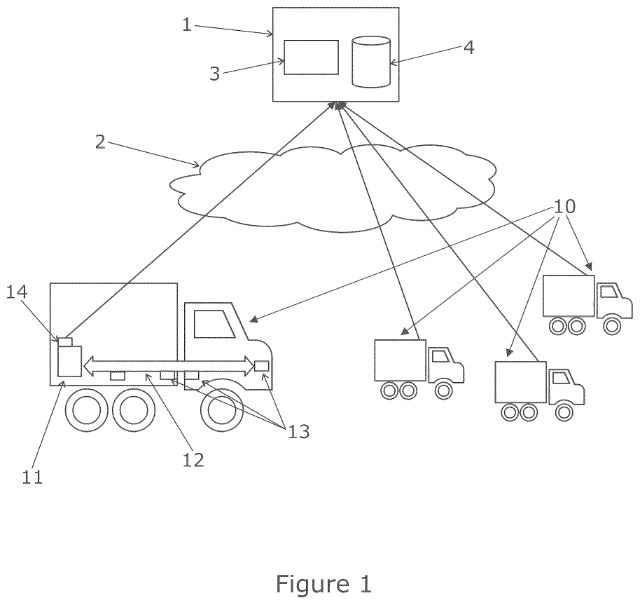

FIG. 1 illustrates a system in which embodiments of the disclosure may be employed—in this case, remote monitoring of transmission systems in a fleet of trucks. A remote diagnostic system 1—implemented as a single server in this example, but potentially implemented by a collection of servers, as a virtual server, or as a cloud-based system—receives data over a communication network 2 (such as the public internet) from trucks 10 in a fleet of trucks. The remote diagnostic system comprises at least a suitably programmed processor 3 and a memory 4. Individual trucks have at least one controller 11 on a vehicle network 12 (in practice, there may be a plurality of controllers 11 on a plurality of vehicle networks 12) interacting with a number or components 13 on the vehicle. The controllers 11 will detect faults either passively (by receiving reports from components) or actively (by interrogating components), therefore learning fault information. The truck 10—in this case, the controller 11—is provided with a communication capability 14 that allows communication with the remote diagnostic system 1.

As previously noted, a diagnostics-enabled component or device will message a controller for its network with a fault code when there is a faulty condition, with the fault code being a combination of a Suspect Part Number (SPN) and a Fault Model Indicator (FMI). In a vehicle network, this may use a J1939 communication protocol. Each SPN/FMI has a fault code identifier that is specific to each device manufacturer.

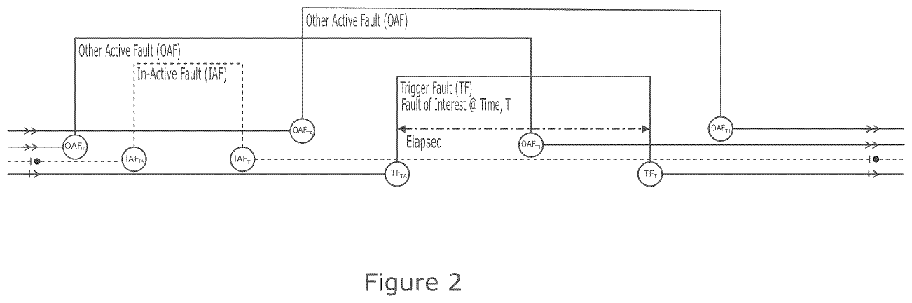

FIG. 2 illustrates different faults and their temporal relationship. The fault code can be categorized into three main categories Trigger Fault (TF), Other-Active Fault (OAF) and In-Active Fault (IAF). These categories can be defined as follows:
Trigger Fault (TF)—This is the subject of a current analysis process—the current fault of interest. By default, the fault is in the inactive state (Is-Active=0)—the default state is normal operation. When specific conditions associated with that fault are met, the fault turns “ON” (i.e. its “Is-Active” state variable changes from 0 to 1), and this point is termed as Triggered Active (TA). Similarly, Triggered Inactive (TI) is the point where the “Is-Active” state variable changes from 1 to 0, or the triggered fault is turned “OFF”. i.e. TF(TA)<TF(TI).
2. Other-Active Faults (OAF) are a set of faults whose “Is-Active” state variable is 1, at TF (TA) i.e. OAF(TA)<TF(TA)<OAF(TI). Such faults may well have a relationship with the trigger fault, but this cannot be determined from timing alone—there may simply be two different faults present.
3. In-Active Faults (IAF) are a set of faults that has turned “ON” and “OFF” before TF(TA), i.e. IAF(TA)<IAF(TI)<TF(TA). Such faults may also be related to the trigger fault if there is a sequential relationship which means that one fault type at one point in time will lead to a different fault type at a later point in time.

In embodiments, faults that only become active after the trigger fault has become inactive could also be considered as a type of potentially relevant In-Active fault (for example, in situations where there is a sequence of related faults, but where the trigger fault TF does not end the sequence. However, fixing TF for mining purposes is desirable for ensuring that causality is properly considered.

The interval between TA and TI may be measured in a number of different ways-time in seconds is an obvious choice, but engine running hours or distance travelled by a vehicle are possible.

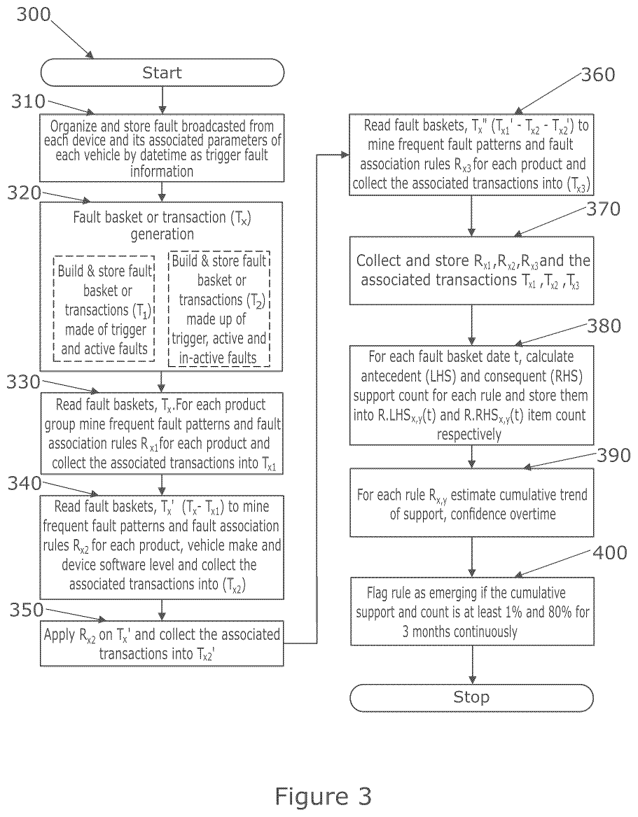

As can be seen from FIG. 2, for a trigger fault broadcast from a controller, there may be multiple other-active faults and multiple in-active faults broadcast from the same controller, or from other controllers in the same vehicle. These other faults may or may not be related to the trigger fault—the presence or absence of such relationships can be determined by data mining to detect regularly occurring patterns involving groups of faults. Understanding these groups of faults—here termed fault-sets—can be used to determine the cause of an overall fault leading to a fault-set. A process according to an embodiment of the disclosure is shown in FIG. 3. This process starts from detection of trigger faults, continues through generation of “fault baskets” of temporally associated faults, analysis of the fault baskets to identify patterns which can be used to establish fault patterns and associated rules, determination of rule importance and associated action.

From the start 300 of the process—which then continues indefinitely—faults are broadcast from the controllers 11 and are organised and stored 310 as trigger faults by the diagnostic system 1. From these trigger faults, two different kinds of “fault basket” (also here termed “transaction”) are constructed 320. The first type of transaction T1 contains only the trigger fault and other active faults for that trigger faults, whereas the second type of transaction T2 contains not only the trigger and active faults, but also in-active faults.

The next steps involve mining the fault baskets to establish patterns. This is done first for product groups—for each of the fault baskets T1 and T2 generated in the previous step, the fault baskets are mined 330 to identify frequent fault patterns and fault association rules Rx1 for each product—the transactions associated with rule Rx1 are collected into Tx1. A similar process is then carried out 340 for each product, vehicle make and device software level—this may establish rules rule Rx2 with associated transactions collected into Tx2. While this is shown as one stage, in principle each hierarchical level may have its own stage in the process.

At this point, a plurality of fault baskets has been established, each by looking for patterns at particular levels of the overall system (product groups, product families, etc. . . . ). Rules established at one level may be used at another level to mine 350 data at this level to obtain additional transactions that obey the rule. For example, rules Rx2 may here be used on transactions that are not in Tx2 but are in another fault basket to determine whether there are additional transactions that follow this rule—these transactions may for example be stored in Tx2′.

At this point, a number of fault baskets have been established. The next step is to determine where there are patterns that are sufficiently frequent to be regarded as genuinely indicative of a particular fault (and which may then, for example, act as a trigger to a maintenance action). The fault baskets are mined 360 for frequent patterns, and rules and associated transactions that qualify are stored 370 under Tx1, Tx2, Tx3.

The following steps relate to the detection of emergent patterns, and hence of emergent causal faults. The first step is to establish to what extent support—such as a maintenance action—has been associated with a fault basket. This is done by calculating 380 an antecedent (LHS) and consequent (RHS)—relative to the fault basket at time t—support count for each rule, which are then stored into R.LHSxy(t) and R.RHSxy(t) respectively. For each rule Rxy, a cumulative trend of support—and consequently of confidence that the rule relates to that support action—is determined 390. A rule is then flagged 400 as emerging if particular parameters are met—in the example shown here, this is that the cumulative support and count are at least 1% and 80% for 3 months continuously.

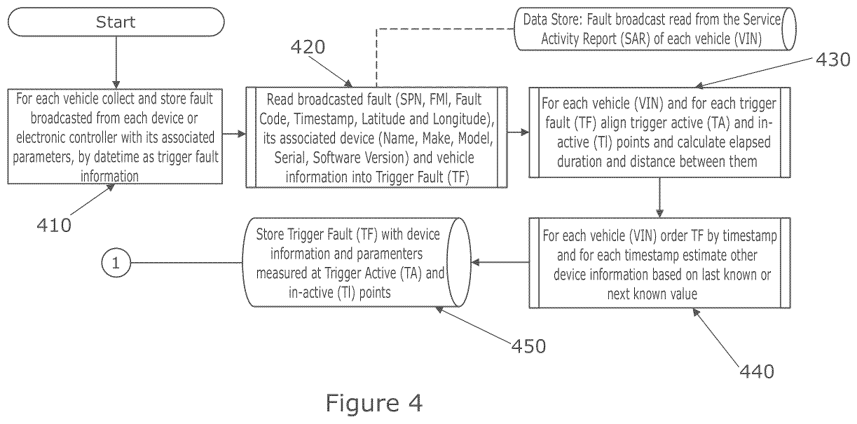

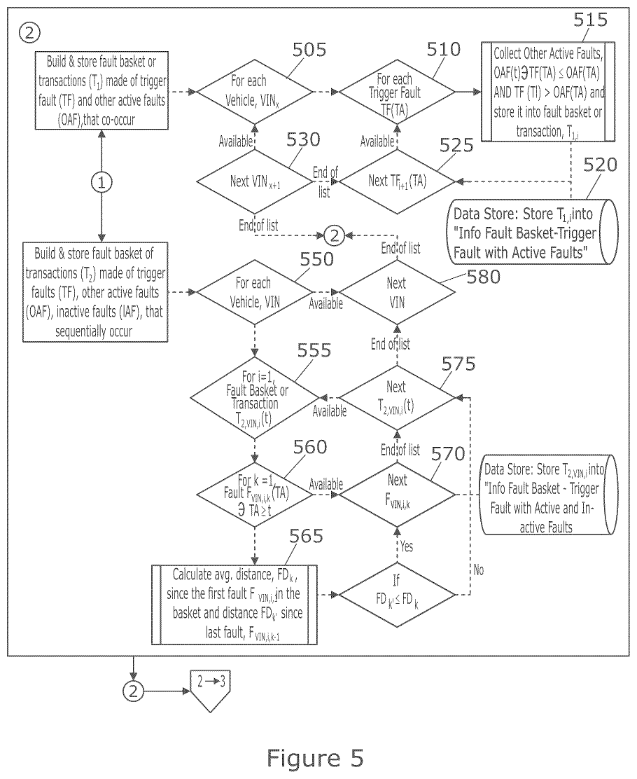

Individual stages will now be described in more detail. The generation of fault baskets—in which faults are classified into affinity groups, which are then established as fault-sets—is shown in FIGS. 4 and 5.

FIG. 4 illustrates the collection and organisation of faults—again, this example relates to faults reported on vehicles to a remote diagnostics system, but it can readily be adapted to other fault reporting arrangements. The process begins 410 with the collection of vehicle faults and associated parameters from each device or electronic controller—this allows trigger fault information to be established. Here, vehicles identified by their Vehicle Identification Number (VIN) produce a Service Activity Report (SAR)—fault information is obtained 420 from here. The diagnostics system reads 420 the broadcast faults from each SAR—in this case, the information collected is not only the Suspect Part Number (SPN) and Fault Model Indicator (FMI) that establish the fault code and a timestamp that indicates its time of occurrence but also a location indicator (here provided as Latitude and Longitude), further details for the faulty component or device (here Name, Make, Model, Serial Number and Software Version) and also vehicle identification (such as VIN, and potentially further details of the configuration of the vehicle, unless this is available in a central repository and can be looked up from the VIN). This information is used to establish a Trigger Fault (TF).

The extent of the trigger fault—as shown in FIG. 2—is determined 430 in the next step. For each trigger fault for each vehicle, trigger active (TA) and trigger in-active (TI) points are determined, and an elapsed duration/distance between them determined. For each VIN, an ordered sequence of trigger faults by timestamp is provided 440, with values of potentially relevant device information (based on last known or next known values) determined for TA and TI points for the trigger fault. Each trigger fault is then stored 450 with device information and parameters for TA and TI points. Establishment of the trigger fault assemblage in this fashion moves the process to point 1 in FIG. 4.

The next step involves the generation of fault baskets for each trigger fault. The rules for this approach will be described below, with reference to FIG. 5. As previously indicated, there are two types of fault basket established: a fault basket comprising the trigger fault and other active faults; and a fault basket comprising the trigger fault, other active faults and also in-active faults. The establishment of each type of fault basket is described below.

The first type of fault basket (or transaction), termed T1, is shown in a first loop beginning at 505, where for each vehicle (VINx), each trigger fault (here identified by its trigger active time, TF(TA)) is assessed 510 and other faults active at the time the trigger fault becomes active are collected 515 in the relevant fault basket T1 for that trigger fault such that:

OAF(t) [symbol] (OAF(TA)−5TF(TA)) AND (OAF(TI)>TF(TA))

This fault basket T1,i is stored 520 in the data store, and the process continues 525 with a further trigger fault if available—if not, then the process moves on to a new vehicle 530 while this is available—when all trigger faults for the vehicle have been assessed, all type T1 fault baskets have been stored.

A similar process is carried out for the second type of fault basket (or transaction), termed T2. Again, a process is started for each vehicle 550 to develop these fault baskets for each trigger fault, starting with the first trigger fault in the assemblage, TFi where i=1—the new fault basket being developed 555 can be identified as T2,VIN,i(t). For each trigger fault, it now needs to be established which faults form part of the fault basket, which is done by using 560 the relation

FVIN,i,k(TA) [symbol] TA2:t

to identify which faults need to be considered. For such a fault, the average distance FDk since the first fault FVIN,i,1 in the basket and the distance FDk′ since the last fault FVIN,i,k−1 are determined 565—if

FDkr−5FDk

then the fault can be added 570 into the fault basket and the process move on to the next value of k—if not, however, further faults are too remote and the process moves on 575 to the next value of i for construction of the next fault basket—a plurality of fault baskets of the form T2,VIN,i are constructed as a result. When all faults for one vehicle have been considered, the process moves on 580 to the next VIN until all vehicles have been considered.

At this point, shown as point 2 on FIG. 5, two sets of fault baskets have been developed a first fault basket T1 containing the trigger fault TF and any other active faults OAF, and a second fault basket T2 containing the trigger fault TF, other active faults OAF, and qualifying inactive faults IAF. The next steps involve mining the fault sets for frequent fault patterns and for determining fault association rules from these patterns.

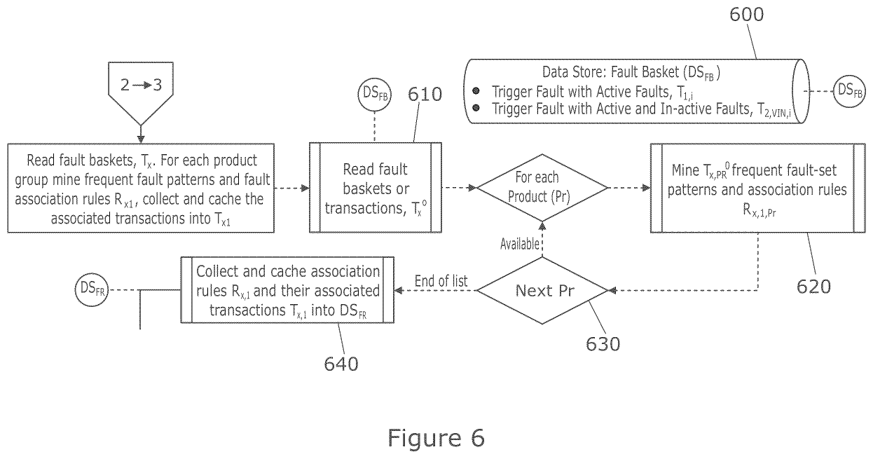

FIG. 6 shows this mining activity at the product level. Fault baskets are stored in the data store 600—as indicated above, these are of two types: fault baskets for a trigger fault i with only active faults (T1,i) and fault baskets for a trigger fault i for a vehicle VIN comprising both active and in-active faults (T2,VIN,i). Firstly, fault baskets are read 610 from the initial assemblage of fault baskets Tx0. For each product Pr, a data mining operation 620 then takes place on the relevant fault sets Tx,Pr0 to determine frequent fault set patterns, and fault association rules Rx,1,Pr. The mining process establishes fault set patterns, and rules, that occur sufficiently frequently that they pass some confidence level for describing genuine relationships rather than chance juxtaposition. Any appropriate mining strategy—such as use of the Apriori algorithm (https://en.wikipedia.org/wiki/Apriori_algorithm) may be used here. When mining is complete for one product, the process moves on 630 to the next product and the loop continues until there are no more products, at which point the association rules Rx,1 that have been established and their associated transactions Tx,1 are stored 640 in the data store 600 (into DSFR).

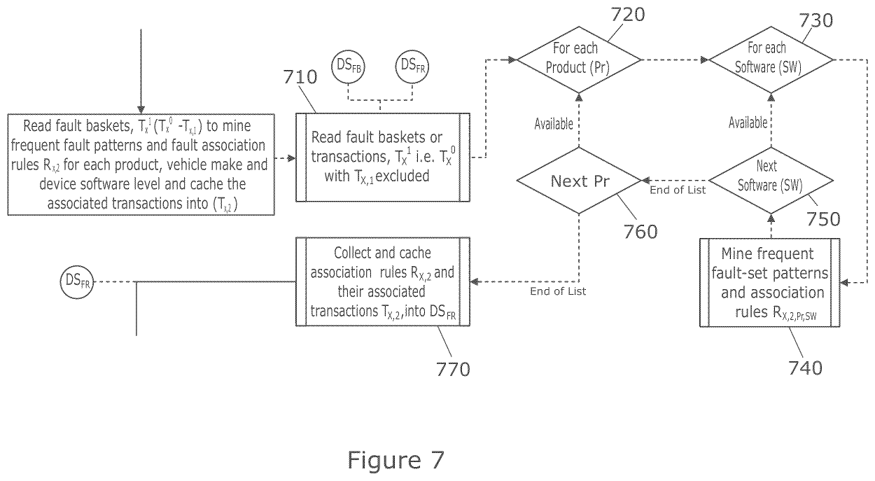

FIG. 7 shows a further mining process to identify patterns, and hence rules, that are not connected to the patterns identified in the FIG. 6 process. The FIG. 6 process should collect faults that are specific to that product family—these may be faults in the device showing the fault code, for example—whereas there are other faults in the system which may manifest in a particular device or component showing a fault code (for example, if the system fault causes the component to be operated far outside its designed operating conditions). The FIG. 7 approach addresses this by using modified fault baskets T1 which exclude transactions Tx, 1 already associated with a rule in order to discover new patterns and hence new rules. First of all, these modified fault baskets are constructed 710 and then a data mining loop begins 720 for a first product. The loop contains a data mining operation step in which the modified fault baskets are mined 740 for a particular parameter 730—software version is shown in FIG. 7—with patterns identified and rules Rx,2,Pr,parameter established as before. Once one parameter value has been mined, the loop advances 750 to the next parameter value (in the FIG. 7 example, the loop advances to a further software version). When one parameter is exhausted, the process can advance 760 to another parameter in the parameter list—for example, vehicle make. When all parameters are exhausted, the loop can advance to a further product. When all products have been evaluated, the identified rules Rx,2,Pr, parameter and their associated transactions Tx,2 are stored 770 in the data store.

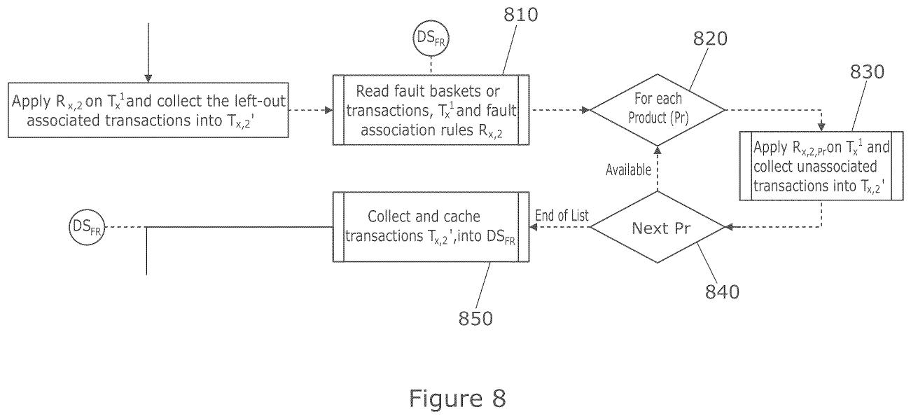

While FIG. 7 shows the development of a new set of rules that are determined from parameters other than products, they may also be relevant to fault sets other than those used to develop the rules, as is shown in the process of FIG. 8. These “left-out” fault sets remaining in Tx1 as still not being associated with a rule are tested 810 for these new fault association rules Rx,2—for each product, 820, each rule Rx,2 is applied 830 to unassociated transactions, and after all products have been considered 840, any transactions that follow the rule are collected 850 into Tx,2′.

When faults that have been identified through working through the processes set out in FIGS. 6 to 8 by product and by parameter, “special cause” faults associated with the product can be identified and associated rules established—these rules and the knowledge that these faults derive from special causes—and so occur with an unexpectedly high frequency for a failure of the relevant type—may be particularly important in determining issues with the product, and for determining when (and what) predictive maintenance is required to prevent serious faults developing—this may be particularly valuable if, for example, there is a warranty associated with the remote diagnostic activity. The identification of special cause faults is shown in FIG. 8. First of all, a limited set of fault baskets 910 is constructed without the more complex fault cases identified by the FIG. 6, FIG. 7 and FIG. 8 processes, that is:

$${Tx}^{″} = Tx {1}^{′} - Tx 2 - Tx {2}^{′}$$

The mining loop now involves for each product 920 mining 930 frequent fault set patterns and associated rules Rx,3 in the same manner as before, then moving on 940 to the next product until no products are left for evaluation. The result is the collection 950 of a third set of rules Rx,3 and associated transactions Tx,3.

At this point, there are now three separate classes of fault rules and associated transactions identified: product faults and associated rules Rx,1 and transactions Tx,1; systemic faults and associated rules Rx,2 and transactions Tx,2; and “special cause” product faults and associated rules Rx,3 and transactions Tx,3. First of all, all these rules and their associated fault baskets/transactions are collected 1010, and then these rules are stored 1020 in the data store DSFR.

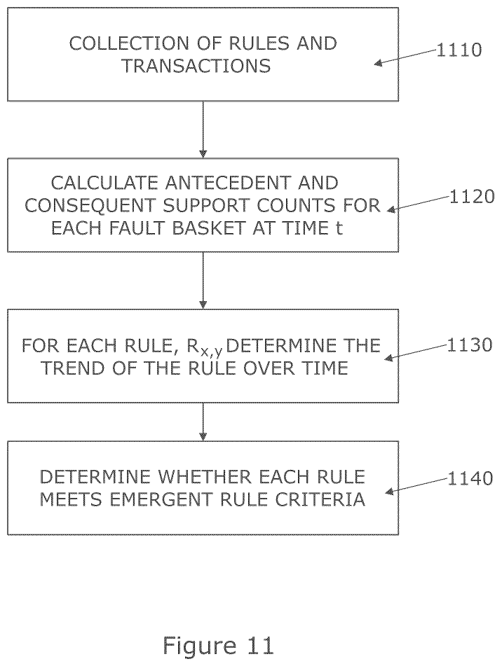

FIG. 11 shows how starting with the collection 1110 of these rules and associated transactions, a process of establishing whether each emerging rule should be persisted—and so used, for example, in a persistent maintenance process—is carried out. Here, this is determined in terms of practical action associated with the fault—for example, in part maintenance or replacement (or other support actions).

The first step is to calculate 1120 for each fault basket of a given time t the support count for each rule—this is determined both before (antecedent—LHS) and after (consequent—RHS) the time of the fault basket. These counts are stored in R.LHSx,y(t) and R.RHSx,y(t) respectively. Storing these values in this way allows the trend of each rule Rx,y over time to be established 1130—the cumulative trend of support actions allows a determination as to whether that the rule qualifies as emerging or established. This can be done by establishing that the rule Rx,y meets 1140 an appropriate criterion—this may be for example that there is a continuous period where instances of the rule are sufficiently high (the example given here is of a cumulative support level and fault count of at least 1% and 80% respectively for a period of three months).

Using this approach, rules can be established, and real-world interventions scheduled—for example, to prevent the occurrence of faults by predictive maintenance. Emerging rules are established—in the case of automotive systems—at fleet level. In some cases, the development of the rule may allow for cause to be established—for example, it may be determined that the rule is associated with the failure in a particular component. If the fault set appears, that component should then be replaced (rather than any other component which may exhibit a fault value as part of the fault set). In other cases, the development of the rule may determine a maintenance plan—for example, it may be established from the rule that a particular component failure becomes likely when the component reaches a particular age, which may determine that an appropriate general maintenance action is to replace this component before it reaches that age. More generally, the existence of an emerging rule allows inspection of vehicles to determine whether a fault which has been determined to be significant is being exhibited in practice.

The skilled person will appreciate that many further embodiments are possible within the spirit and scope of the disclosure set out here. While the context of fault analysis for vehicle maintenance is discussed in particular here, other embodiments may relate to fault analysis in other systems (for example, a manufacturing plant, which may similarly have faults reported on multiple control systems). Real world actions to be taken may involve predictive maintenance, but they may for other systems involve other real world actions responsive to a determined rule.

1. A computer-implemented method of addressing faults in a system comprising at least one controller, wherein the method comprises:
receiving fault information from the at least one controller for one or more faults, wherein the fault information comprises at least an identification of the device showing the fault and a time period during which the fault occurs;
establishing a plurality of fault baskets, wherein each fault basket for a fault comprises that fault and at least other faults in the system active at the time the fault occurs;
mining the plurality of fault baskets to identify one or more fault rules and associated fault baskets;
determining whether each fault rule meets a significance threshold; and
establishing a corrective or preventative action for fault rules that meet the significance threshold.

2. The method of claim 1, wherein a fault basket also contains inactive faults which were active before the start of the fault for which the fault basket is established but which also became inactive before the start of the fault for which the fault basket is established.

3. The method of claim 2, wherein said inactive faults are included in the fault basket if they meet a proximity threshold.

4. The method of claim 2 wherein each fault has associated with it a fault basket including only other active faults and a fault basket including both other active faults and inactive faults.

5. The method of claim 1, wherein the step of mining the plurality of fault baskets comprises a plurality of fault basket mining stages, wherein for each mining stage, fault rules are established, and one or more fault baskets are associated with each fault rule, and for subsequent mining stages, only fault baskets not already associated with a fault rule are considered.

6. The method of claim 5, wherein a first mining stage involves establishing fault rules common to a device or device family in which the fault occurs.

7. The method of claim 6, wherein one or more subsequent mining stages involve establishing fault rules common to a product incorporating or associated with a device or device family in which the fault occurs or having a common system parameter in a system incorporating the device or device family in which the fault occurs.

8. The method of claim 5, wherein a subsequent mining stage involves applying a fault rule established at an earlier mining stage to fault baskets not yet associated with any fault rule.

9. The method of claim 1, wherein determining whether each fault rule meets a significance threshold comprises determining whether that fault rule is established or emerging.

10. The method of claim 1, wherein method steps are carried out by a diagnostics system, and wherein the diagnostics system receives fault information from a plurality of controllers in a plurality of different systems having devices of the same type therein.

11. The method of claim 10, wherein the diagnostics system is remote from the plurality of controllers and receives fault information from the plurality of controllers over one or more networks.

12. A method of determining maintenance actions for a device or for a product comprising a device, wherein, the method comprises a method of addressing faults in a system as claimed in claim 1, and further comprising determining a maintenance schedule for the device or the product containing the device to carry out the corrective or preventative actions for fault rules that meet the significance threshold established thereby.

13. The method of claim 12, wherein the product is a vehicle.

14. The method of claim 13, wherein the device is a transmission or an engine.

15. A diagnostics system being a computer system having a processor and a memory, wherein the diagnostics system is programmed to perform the method of claim 1.

16. The diagnostics system of claim 15, wherein the diagnostics system comprises a network connection and is adapted to receive fault information from a plurality of controllers from a plurality of systems using the network connection.
